(19) United States
(12) Patent Application Publication
(10) Pub. No.: US 2026/0216824 A1
(43) Pub. Date: Jul. 30, 2026

(54) LASER WELDING METHOD

(71) Applicant: PANASONIC INTELLECTUAL PROPERTY MANAGEMENT CO., LTD., Osaka (JP)

(72) Inventors: Futoshi TSUTSUMI, Hyogo (JP); Naohiko KOBATA, Kyoto (JP); Naoya KATO, Osaka (JP)

(21) Appl. No.: 19/573,843

(22) Filed: Mar. 20, 2026

Related U.S. Application Data
(63) Continuation of application No. PCT/JP2024/032993, filed on Sep. 13, 2024.

(30) Foreign Application Priority Data
Sep. 22, 2023 (JP) 2023-159150

(51) Int. Cl. B23K 26/242; B23K 103/12

(52) U.S. Cl. CPC B23K 26/242; B23K 2103/12

(57) ABSTRACT

A laser welding method for jointing stacked metal foils in which a plurality of copper-based foils are stacked and a tab plate formed of a copper-based material is provided. The laser welding method includes placing one end of the stacked metal foils on the tab plate; irradiating a plurality of tack welding positions on the one end of the stacked metal foils with a blue laser beam; and irradiating a welding line on the tab plate along the one end of the stacked metal foils with the blue laser beam.

### CROSS-REFERENCE TO RELATED APPLICATIONS

This is a continuation of International Application No. PCT/JP2024/032993 filed on September 13, 2024, and claims priority from Japanese Patent Application No. 2023-159150 filed on September 22, 2023, the entire content of which is incorporated herein by reference.

### TECHNICAL FIELD

The present disclosure relates to a laser welding method.

### BACKGROUND ART

Patent Literature 1 discloses a method for joining stacked metal foils, which includes a first step of temporarily joining a plurality of metal foils such that adjacent metal foils are in close contact with each other in a state in which the metal foils are stacked, and a second step of performing non-contact welding on the temporarily joined close contact portions.

### CITATION LIST

### PATENT LITERATURE

Patent Literature 1: JP2014-140890A

### SUMMARY OF INVENTION

An object of the present disclosure is to provide a laser welding method for joining a plurality of metal foils and a metal plate.

The present disclosure provides a laser welding method for joining stacked metal foils in which a plurality of copper-based foils are stacked and a tab plate formed of a copper-based material, the laser welding method including a step of placing one end of the stacked metal foils on the tab plate, a step of irradiating a plurality of tack welding positions on the one end of the stacked metal foils with a blue laser beam, and a step of irradiating a welding line on the tab plate along the one end of the stacked metal foils with the blue laser beam.

According to the present disclosure, it is possible to make intervals between the adjacent metal foils in a stacking direction substantially constant from an upper end side in the stacking direction, which is close to a surface of the stacked metal foils, to a lower end side in the stacking direction regardless of a deviation of a radiation position of laser light and variation in the metal foils.

### BRIEF DESCRIPTION OF DRAWINGS

FIG. 1 is a schematic view showing a configuration example of a blue laser welding system according to Embodiments 1 to 3;

FIG. 2 is a schematic view showing a cross section of a laser oscillator taken along a line A-A in FIG. 1;

FIG. 3 shows an example of a laser welding method for stacked metal foils and a tab plate by a laser welding method in the related art;

FIG. 4 shows an example of a relationship between a focal length of a blue laser beam and spatters;

FIG. 5 shows an example of laser-welding the stacked metal foils and the tab plate in a focal position (= −2.5 mm);

FIG. 6 shows an example of a laser welding result of the stacked metal foils and the tab plate shown in FIG. 5;

FIG. 7 shows an example of a laser welding method for stacked metal foils and a tab plate according to Embodiment 2;

FIG. 8 shows an example of a laser welding result of the stacked metal foils and the tab plate shown in FIG. 7;

FIG. 9 shows an example of a laser welding method for stacked metal foils and a tab plate according to a modification of Embodiment 2;

FIG. 10 shows an example of a change in amplitude of laser welding;

FIG. 11 is a process view schematically showing time-series operation procedures when laser-welding the stacked metal foils and the tab plate;

FIG. 12 shows an example of a laser welding result of the stacked metal foils and the tab plate shown in FIG. 7;

FIG. 13 shows an example of a laser welding method for stacked metal foils and a tab plate according to Embodiment 3;

FIG. 14 shows an example of a laser welding result of the stacked metal foils and the tab plate shown in FIG. 13; and

FIG. 15 is a cross-sectional view of a weld bead taken along a line B-B in FIG. 14.

### DESCRIPTION OF EMBODIMENTS

### Background of Present Disclosure

It is known that laser welding for a copper-based material containing copper as a main component is fairly difficult since the copper-based material generally has high reflectance, high thermal conductivity, and high heat capacity. Welding methods such as infrared (IR) laser welding using light having a wavelength in an IR band and ultrasonic welding have been developed as laser welding for the copper-based material. Even when these welding methods are used, however, it is said that it is still difficult to perform high-quality laser welding on the copper-based material while shortening a takt time. A product obtained by stacking and laser-welding the copper-based material is used as, for example, an electrode of a secondary battery (battery) mounted on an electronic device or an autonomous vehicle. Therefore, a technique for welding the copper-based material with high quality inevitably attracts attention in consideration of battery production. That is, there is a demand for a laser welding technique that shortens the takt time and achieves excellent welding quality.

In a configuration of Patent Literature 1, to stack and join a plurality of metal foils, a welding target portion of a workpiece is sandwiched between a pair of electrodes and prescribed pressure is applied to bring the plurality of metal foils into contact, and then the pair of electrodes are energized so that Joule heat is applied to the metal foils in contact with each other to perform temporary joining (tack welding step). However, when the tack welding step using the electrodes and a welding step by laser welding are performed in this manner, the number of manufacturing steps may increase since these steps are executed in different steps using different facilities.

Further, recent years have seen demands for a technique for joining a plurality of metal foils and a metal plate formed of a copper-based material by laser welding in manufacturing an electrode or the like of a secondary battery (battery) mounted on an electronic device or an autonomous vehicle. However, when a method for joining stacked metal foils described in Patent Literature 1 is applied to the joining of the plurality of metal foils and the metal plate formed of the copper-based material, the number of manufacturing steps may increase due to the addition of the tack welding step as described above.

Therefore, in each of following embodiments, an example of a laser welding method for joining a plurality of metal foils and a metal plate will be described.

Hereinafter, embodiments specifically disclosing a laser welding method according to the present disclosure will be described in detail with reference to the drawings as appropriate. Detailed description more than necessary may be omitted. For example, detailed description of well-known matters and redundant description of substantially the same configuration may be omitted. This is to avoid redundancy of following description and facilitate understanding of those skilled in the art. The accompanying drawings and the following description are provided for those skilled in the art to fully understand the present disclosure, and are not intended to limit subject matters described in the claims.

### DEFINITIONS OF TERMS

In the following description, a term "laser welding" has a meaning as wide as possible unless otherwise explicitly described, and includes welding, soldering, melting and refining, joining, annealing, softening, adhesion, resurfacing, peening, heat treatment, fusion, sealing, and stacking.

In the following description, a term "copper-based material" has a meaning as wide as possible unless otherwise explicitly described, and includes any one of copper, a copper material, a copper metal, a material electroplated with copper, a metal material containing at least substantially 10 wt% to 100 wt% of copper, a metal and an alloy that contain at least substantially 10 wt% to 100 wt% of copper, a metal and an alloy that contain at least substantially 20 wt% to 100 wt% of copper, a metal and an alloy that contain at least substantially 50 wt% to 100 wt% of copper, a metal and an alloy that contain at least about 70 wt% to 100 wt% of copper, and a metal and an alloy that contain at least substantially 90 wt% to 100 wt% of copper.

In the following description, terms "blue laser beam" and "blue laser" have a meaning as wide as possible unless otherwise explicitly described, and generally refer to a system that provides a laser beam, a laser beam, and a laser source (for example, diode laser) that provides and propagates a laser beam or light having a wavelength of substantially 400 nm to substantially 500 nm.

### System Configuration

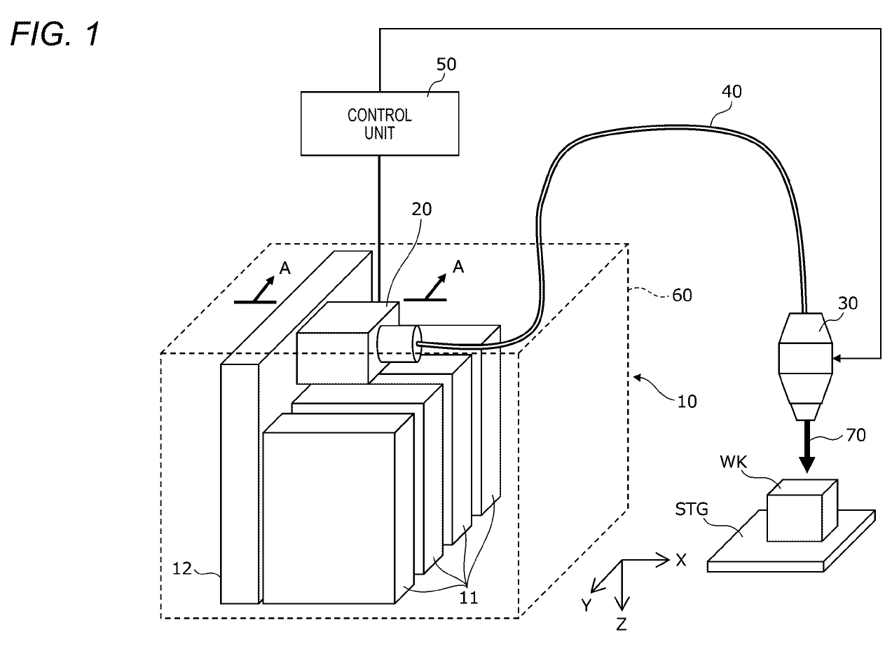

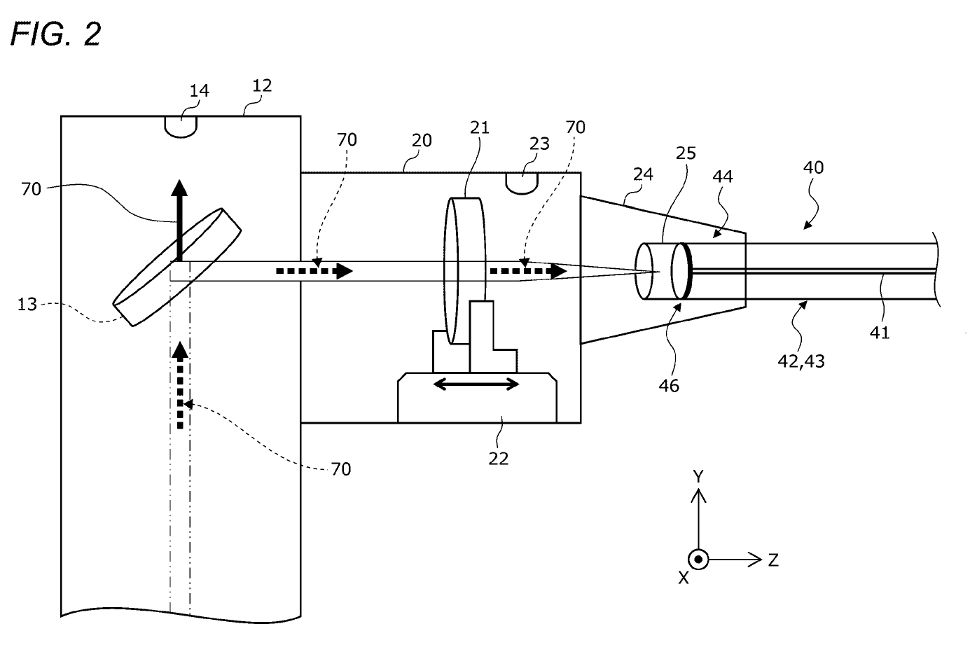

First, a configuration example of a blue laser welding system 100 according to Embodiments 1 to 3 will be described with reference to FIGS. 1 and 2. FIG. 1 is a schematic view showing the configuration example of the blue laser welding system 100 according to Embodiments 1 to 3. FIG. 2 is a schematic view showing a cross section of a laser oscillator taken along a line A-A in FIG. 1.

In the following description, X, Y, Z axes are defined as directions shown in FIGS. 1 and 2. That is, a direction in which a blue laser beam 70 in FIG. 2 travels toward a semi-transparent mirror 13 is defined as a Y direction, a direction from the semi-transparent mirror 13 toward a transmission fiber 40 is defined as a Z direction, and a direction orthogonal to the Y direction and the Z direction is defined as an X direction. The Z direction coincides with an optical axis direction of the blue laser beam 70 exiting from a condenser lens unit 20 within a range of assembly tolerance of an optical system of the blue laser welding system 100.

As shown in FIG. 1, the blue laser welding system 100 includes a laser oscillator 10, the condenser lens unit 20, a laser head 30, the transmission fiber 40, a control unit 50, and a stage STG. The laser oscillator 10, the condenser lens unit 20, and a laser beam entrance portion 44 (see FIG. 2) of the transmission fiber 40 are accommodated in a housing 60. Here, in the present embodiment, laser light (blue laser beam 70) having a wavelength of blue light (that is, 400 nm to 500 nm) is used when laser-welding stacked metal foils. This is because light having a wavelength of blue light has a characteristic of being absorbed by copper at a high absorption rate (up to substantially 65%).

The laser oscillator 10 includes a plurality of laser modules 11 and a beam combiner 12. Four laser modules 11 are shown in FIG. 1, and the number of laser modules is not limited to four and may be one. When the laser oscillator 10 includes one laser module 11, a configuration of the beam combiner 12 may be simplified. In the laser oscillator 10, laser beams of different wavelengths (different wavelengths such as 400 nm, 420 nm, 440 nm, and 480 nm in the range of 400 nm to 500 nm) emitted from the respective plurality of laser modules 11 are combined into one blue laser beam 70 by the beam combiner 12. The laser oscillator 10 may also be referred to as a direct diode laser (DDL) oscillator. The laser module 11 itself includes a plurality of laser diodes, for example, a semiconductor laser array.

As shown in FIG. 2, the blue laser beam 70 combined by the beam combiner 12 is condensed by a condenser lens 21 disposed in the condenser lens unit 20 and enters the transmission fiber 40. By configuring the laser oscillator 10 as described above, it is possible to obtain the high-power blue laser welding system 100 having a laser beam output exceeding several kW. The beam combiner 12 includes the semi-transparent mirror 13 and an output light monitor 14 therein.

The semi-transparent mirror 13 deflects the blue laser beam 70 wavelength-combined by the beam combiner 12 toward the condenser lens unit 20 and transmits a part (for example, 0.1%) of the blue laser beam 70.

The output light monitor 14 is disposed in the beam combiner 12, receives the blue laser beam 70 transmitted through the semi-transparent mirror 13, and generates a detection signal corresponding to the light amount of the received blue laser beam 70. The laser oscillator 10 is supplied with electric power from a power supply device (not shown) to perform laser oscillation.

The condenser lens unit 20 includes therein the condenser lens 21, a slider 22, and a reflected light monitor 23. The condenser lens 21 condenses the blue laser beam 70 on an entrance end surface 46 of the transmission fiber 40 such that a spot diameter is smaller than a diameter of a core 41 of the transmission fiber 40. The slider 22 holds the condenser lens 21 such that the condenser lens 21 is automatically movable in the Z direction according to a control signal from the control unit 50. The slider 22 is coupled to, for example, a ball screw (not shown) driven by a motor (not shown), and moves in the Z direction as the ball screw rotates. The slider 22 mainly moves in the X and Y directions during initial position adjustment of an optical system, and moves along the Z direction during shift compensation of a focal position. The slider 22 may be manually or automatically moved in the X and Y directions. In a case of automatic movement, the slider 22 is coupled to the above-described ball screw (not shown) or the like. The reflected light monitor 23 receives the blue laser beam 70 reflected or scattered by the laser beam entrance portion 44 of the transmission fiber 40, and generates a detection signal corresponding to the light amount of the received blue laser beam 70. The condenser lens unit 20 further includes a connector 24. The laser beam entrance portion 44 of the transmission fiber 40 is connected to the connector 24. The connector 24 holds a quartz block 25 provided in contact with the entrance end surface 46 of the transmission fiber 40. The quartz block 25 has a function of protecting the entrance end surface 46.

The transmission fiber 40 is optically joined to the laser oscillator 10 and the condenser lens 21, and transmits the blue laser beam 70 received from the laser oscillator 10 through the condenser lens 21 to the laser head 30. The transmission fiber 40 includes the core 41 that transmits the blue laser beam 70, a cladding 42 that is provided around the core 41 and has a function of confining the blue laser beam 70 in the core 41, and a coating film 43 that covers a surface of the cladding 42. The laser beam entrance portion 44 of the transmission fiber 40 is provided with a mode stripper (not shown) on the connector 24. Here, the mode stripper is a mechanism for preventing the blue laser beam 70 leaking into the cladding 42 from propagating in the cladding 42 when the blue laser beam 70 is guided to the core 41, and eliminates the blue laser beam 70 leaking into the cladding 42 by converting the blue laser beam 70 into heat. Although not shown, a mode stripper is also installed on a connector on a laser beam exiting side of the transmission fiber 40 to remove the blue laser beam 70 that was not completely eliminated on an entrance side (that is, a laser beam entrance portion 44 side) and propagated through the cladding 42 immediately before exiting.

The laser head 30 radiates the blue laser beam 70 transmitted through the transmission fiber 40 toward an outside (for example, stacked metal foils to be described later). The laser head 30 includes, for example, a collimator, a reflecting mirror, a condenser lens, and a laser light scanner as optical components. These optical components are accommodated in a housing of the laser head 30 while maintaining a prescribed positional relationship (for example, see FIGS. 1 and 2 of JP2022-60808A). The laser head 30 is coupled to a driving unit (not shown) and is displaceable in the Y direction according to a control signal from the control unit 50. The blue laser welding system 100 changes a focal position of the blue laser beam 70 by displacing the laser head 30 in the Z direction, and appropriately radiates the blue laser beam 70 according to a shape of a workpiece WK (specifically, stacked metal foils AF and tab plate TB).

The adjustment of the focal position of the blue laser beam 70 may be implemented by a collimator. In this case, the collimator receives the blue laser beam 70 exiting from the transmission fiber 40, and converts the blue laser beam 70 into parallel light to enter the reflecting mirror. The collimator is coupled to a driving unit (not shown) and is displaceable in the Y direction according to a control signal from the control unit 50. By displacing the collimator in the Y direction, the focal position of the blue laser beam 70 can be changed, and the blue laser beam 70 can be appropriately radiated according to the shape of the workpiece WK (for example, stacked metal foils AF and tab plate TB). That is, the collimator also functions as a focal position adjustment mechanism for the blue laser beam 70 in combination with the driving unit (not shown). The focal position of the blue laser beam 70 may be changed by displacing the condenser lens by a driving unit (not shown).

The reflecting mirror reflects the blue laser beam 70 transmitted through the collimator to enter the laser light scanner. A surface of the reflecting mirror defines substantially 45 degrees with an optical axis of the blue laser beam 70 transmitted through the collimator.

The condensing lens 21 condenses the blue laser beam 70 reflected by the reflecting mirror and scanned by the laser light scanner on a surface of the workpiece WK placed on the stage STG.

The laser light scanner is a known galvano scanner including a first galvano mirror and a second galvano mirror. The first galvano mirror includes a first mirror, a first rotation shaft, and a first driving unit. The second galvano mirror includes a second mirror, a second rotation shaft, and a second driving unit. The blue laser beam 70 transmitted through the condenser lens is reflected by the first mirror and further reflected by the second mirror, and is radiated to the surface of the workpiece WK.

For example, the first driving unit and the second driving unit are galvano motors, and the first rotation shaft and the second rotation shaft are output shafts of the motors. Although not shown, the first driving unit is rotationally driven by a driver that operates according to a control signal from the control unit 50, and thereby the first mirror attached to the first rotation shaft rotates about an axis of the first rotation shaft. Similarly, the second driving unit is rotationally driven by a driver that operates according to a control signal from the control unit 50, and thereby the second mirror attached to the second rotation shaft rotates about an axis of the second rotation shaft.

The first mirror is rotated to a prescribed angle about the axis of the first rotation shaft, and thereby the blue laser beam 70 is directed in the X direction. The second mirror is rotated to a prescribed angle about the axis of the second rotation shaft, and thereby the blue laser beam 70 is directed in the Z direction. That is, the laser light scanner two-dimensionally scans the blue laser beam 70 in an XZ plane and radiates the blue laser beam 70 toward the workpiece WK.

The laser head 30 includes, for example, a collimator, a reflecting mirror, a condenser lens, and a laser light scanner as optical components. These optical components are accommodated in a housing of the laser head 30 while maintaining a prescribed positional relationship (for example, see FIGS. 1 and 2 of JP2022-060808A).

For example, when the blue laser welding system 100 is used for welding (for example, joining) the workpiece WK constituted by the stacked metal foils AF, which are a plurality of metal foils, and the tab plate TB, the blue laser beam 70 is emitted toward the workpiece WK disposed in a prescribed position on the stage STG. The stage STG may be movable on one or more of the X, Y, and Z axes, and may enable adjustment of a radiation position or radiation posture of the blue laser beam 70 on the workpiece WK.

The control unit 50 controls laser oscillation of the laser oscillator 10. Specifically, the control unit 50 controls laser oscillation by controlling an output, ON time, and the like of a power supply device (not shown) connected to the laser oscillator 10. The control unit 50 may further include a lens movement control unit (not shown). The lens movement control unit (not shown) receives detection signals of the reflected light monitor 23 and the output light monitor 14 and moves the slider 22 to adjust the condenser lens 21 to a desired position. When the blue laser welding system 100 is used for welding (for example, joining) the plurality of copper foils described above, the control unit 50 may control operation of a manipulator (not shown) to which the laser head 30 is attached.

In following description, a laser welding method for welding and joining a plurality of metal foils formed of a copper-based material (hereinafter, referred to as "stacked metal foils") and a metal plate formed of a copper-based material (hereinafter, referred to as "plate tab") performed by the blue laser welding system 100 will be described.

### Background of Embodiment 1

In general, laser welding is a welding method with a high power density, and thus spatters are likely to occur. Spatters may cause a short circuit by being caught between copper foils, and may cause a product defect of a battery or the like in which a manufactured workpiece (joined body of stacked metal foils AF and tab plate TB) is assembled. Therefore, in the welding of the stacked metal foils AF and the tab plate TB, it is desirable to set a welding condition leading to no spatters. Therefore, in Embodiment 1 described below, a focal position of a blue laser beam for more stably welding the stacked metal foils AF and the tab plate TB will be described.

### Embodiment 1

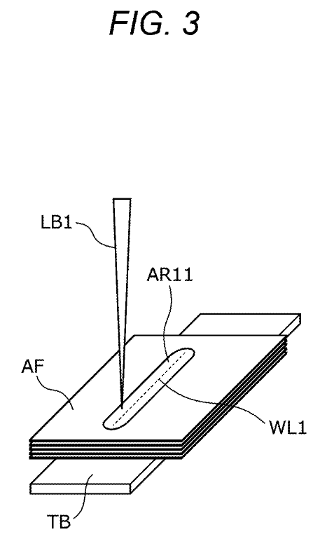

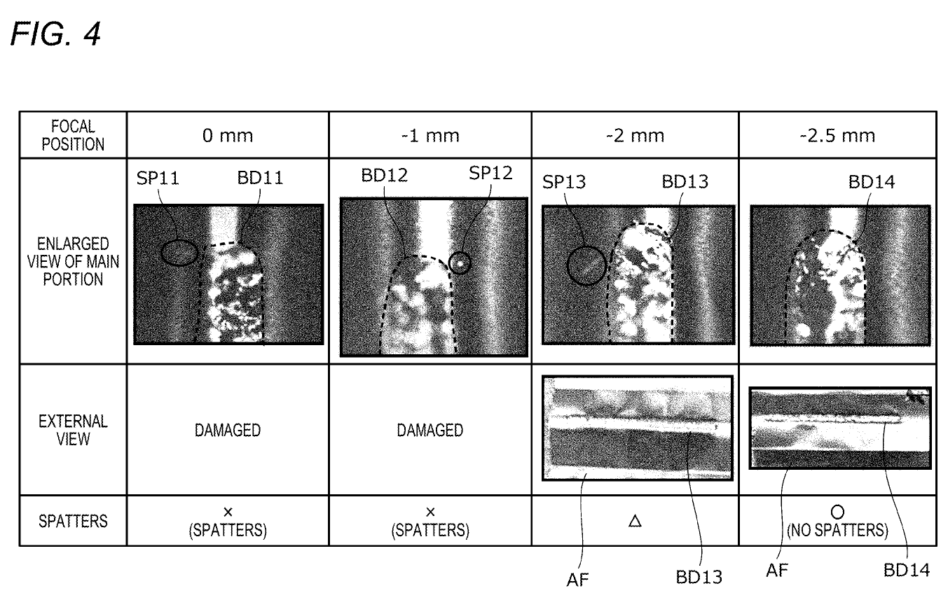

A laser welding method according to Embodiment 1 will be described with reference to FIGS. 3 and 4. FIG. 3 shows an example of a laser welding method for the stacked metal foils AF and the tab plate TB by a laser welding method in the related art. FIG. 4 shows an example of a relationship between a focal length of a blue laser beam LB1 and spatters.

The laser welding method in the related art shown in FIG. 3 shows a state in which laser welding in the related art is performed, in which the stacked metal foils AF and the tab plate TB, which constitute the workpiece WK, are irradiated with the blue laser beam LB1. The blue laser welding system 100 performs welding by wobbling (rotating) and radiating the blue laser beam LB1 on a welding line WL1 set on the stacked metal foils AF that are a plurality of copper foils on the tab plate TB. After the radiation of the blue laser beam LB1, a weld bead is formed on the stacked metal foils AF and the tab plate TB in a radiation range AR11 of the blue laser beam LB1. FIG. 4 shows presence and absence of spatters when a focal position of the blue laser beam LB1 is changed to 0 (zero) mm, −1 mm, −2 mm, and −2.5 mm in such a laser welding method.

The focal position referred to here is a position (height) along a Z-axis direction, and indicates a position (height) in which a beam spot diameter of the blue laser beam LB1 radiated to the workpiece is smallest. When the blue laser beam LB1 is radiated with the focal position adjusted to 0 (zero) mm, the beam spot diameter is smallest in a welding position (height) on the workpiece. That is, as the focal position of the blue laser beam LB1 becomes closer to 0 (zero) mm, the beam spot diameter in a radiation position decreases and a power density increases. On the other hand, as the focal position of the blue laser beam LB1 becomes smaller in a negative number, a distance between the workpiece and the laser head 30 increases, the beam spot diameter radiated on the workpiece increases, and the power density decreases.

In the stacked metal foils AF and the tab plate TB irradiated with the blue laser beam LB1 in the focal position = 0 (zero) mm, a weld bead BD11 is formed, and damage to the stacked metal foils AF and spatters SP11 due to an excessively high power density of the blue laser beam LB1 occur.

In the stacked metal foils AF and the tab plate TB irradiated with the blue laser beam LB1 in the focal position = −1 mm, a weld bead BD12 is formed, and damage to the stacked metal foils AF and spatters SP12 due to an excessively high power density of the blue laser beam LB1 occur.

In the stacked metal foils AF and the tab plate TB irradiated with the blue laser beam LB1 in the focal position = −2 mm, a weld bead BD13 is formed, and spatters SP13 occur. The spatters SP13 generated here are sufficiently small and few as compared with the spatters SP11, SP12 generated when the focal position = 0 (zero) mm and 1 mm, which is not determined as a welding failure.

In the stacked metal foils AF and the tab plate TB irradiated with the blue laser beam LB1 in the focal position = −2.5 mm, a weld bead BD14 is formed, and no spatters occur.

As described above, the blue laser welding system 100 according to Embodiment 1 can reduce the power density of the blue laser beam LB1 and restrict spatters by setting the focal position of the blue laser beam LB1, which is one of welding conditions, to −2 mm or smaller. Accordingly, by more effectively restricting a welding failure due to spatters in the welding of the stacked metal foils AF and the tab plate TB, the blue laser welding system 100 can further stabilize manufacturing of a product (workpiece) obtained by joining the stacked metal foils AF and the tab plate TB. The focal position of the blue laser beam LB1 is preferably −2.5 mm, and may also be −2 mm or smaller.

Further, the blue laser welding system 100 can further increase a distance between the laser head 30 and the stacked metal foils AF irradiated with the blue laser beam LB1 by setting the focal position of the blue laser beam LB1 to −2 mm or smaller. Therefore, the blue laser welding system 100 can protect protective glass of the laser head 30 from spatters, fumes, and the like even when spatters, fumes, and the like are generated during laser welding. Accordingly, the blue laser welding system 100 can further reduce a replacement frequency of the protective glass and further improve a manufacturing efficiency of the product (workpiece) obtained by joining the stacked metal foils AF and the tab plate TB.

### Background of Embodiment 2

In Embodiment 1, when laser welding is performed, in which the focal position of the blue laser beam LB1 is adjusted to each of 0 (zero) mm to −2.5 mm and the blue laser beam LB1 is wobbled and radiated onto the welding line WL1, a welding result that the stacked metal foils AF or the tab plate TB are damaged is obtained.

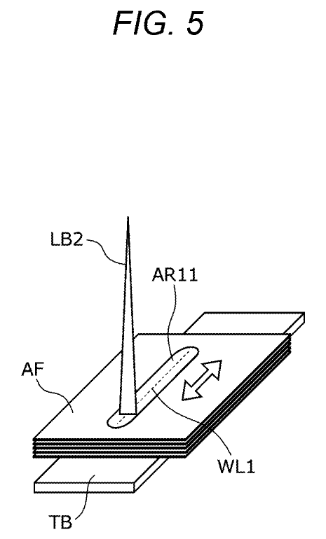

Therefore, to examine a method of radiating a blue laser beam suitable for welding the stacked metal foils AF and the tab plate TB, as shown in FIG. 5, the laser welding for the stacked metal foils AF and the tab plate TB was performed by a laser welding method in which, in the welding method according to Embodiment 1, the focal position of the blue laser beam LB1 was adjusted to −2.5 mm, a blue laser beam LB2 was linearly radiated without wobbling, and the radiation of the blue laser beam LB2 continue to reciprocate three times on the welding line WL1.

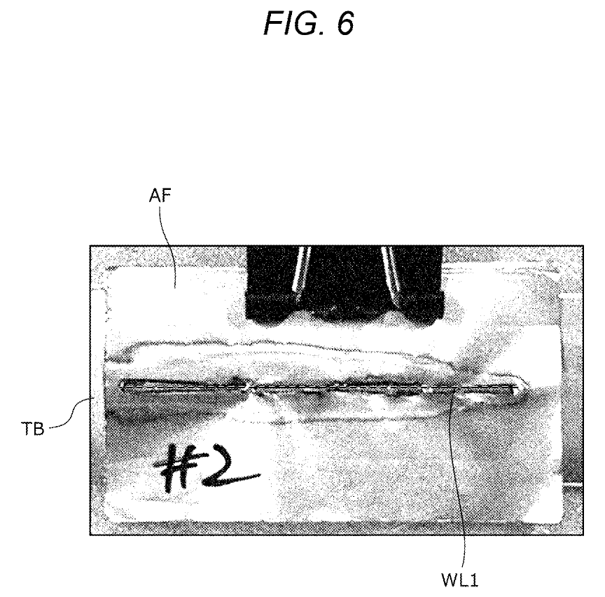

FIG. 5 shows an example of laser-welding the stacked metal foils AF and the tab plate TB in the focal position (= −2.5 mm) shown in Embodiment 1. FIG. 6 shows an example of a laser welding result of the stacked metal foils AF and the tab plate TB shown in FIG. 5.

The blue laser welding system 100 performs laser welding by a laser welding method shown in FIG. 5. Although the stacked metal foils AF after laser welding have restricted spatters by adjusting the focal position of the blue laser beam LB2, the stacked metal foils AF may be fused (damaged) along a radiation trajectory (welding line WL1) of the blue laser beam LB2 due to the three reciprocating radiations of the blue laser beam LB2.

Therefore, in following Embodiment 2, a radiation method of the blue laser beam LB2 that is more suitable for joining the stacked metal foils AF and the tab plate TB will be described. In the following description, the same components as those in Embodiment 1 are denoted by the same reference numerals, and thus the description thereof will be omitted. In the laser welding method described in Embodiment 2, the focal position of the blue laser beam LB2 is adjusted to −2.5 mm.

### Embodiment 2

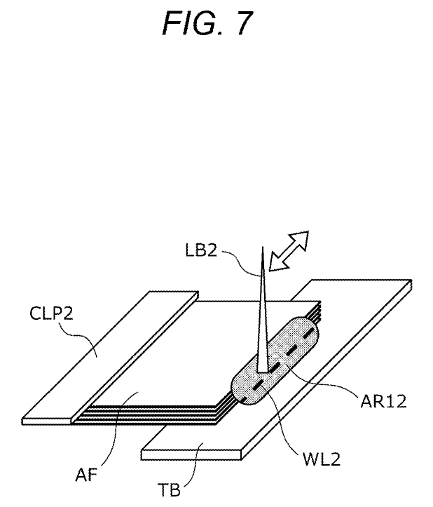

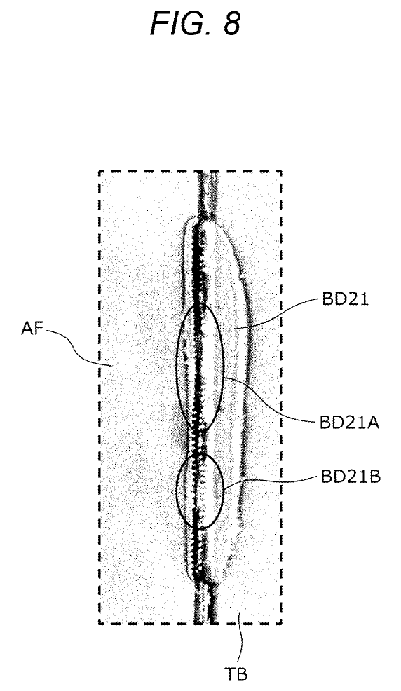

A laser welding method according to Embodiment 2 will be described with reference to FIGS. 7 and 8. FIG. 7 shows an example of a laser welding method for the stacked metal foils AF and the tab plate TB according to Embodiment 2. FIG. 8 shows an example of a laser welding result of the stacked metal foils AF and the tab plate TB shown in FIG. 7.

The blue laser welding system 100 according to Embodiment 2 welds the stacked metal foils AF and the tab plate TB by a welding method of reciprocating the blue laser beam LB2 on a welding line WL2 a plurality of times such that a radiation trajectory of the blue laser beam LB2 draws a freely set radiation trajectory. Here, the radiation trajectory of the blue laser beam LB2 is freely set in advance by a user. The blue laser beam LB2 is radiated to draw a shape (for example, a sine wave, a circle, an ellipse, or a figure of "8") freely set in advance by the user. In the laser welding method according to Embodiment 2, the welding line WL2 is set on the tab plate TB along one end portion (broken portion) of the stacked metal foils AF that are placed on the tab plate TB and in which a plurality of copper foils are stacked. Another end portion of the stacked metal foils AF is clamped by a clamp CLP2 to prevent misalignment between the stacked copper foils. A radiation range AR12 indicates a radiation range of the blue laser beam LB2 radiated along a freely set radiation trajectory during welding.

A weld bead BD21 formed by the laser welding method shown in FIG. 7 includes joint portions BD21A, BD21B at which the stacked metal foils AF and the tab plate TB are joined. The weld bead BD21 is formed in a state in which copper foils (stacked metal foils AF) which are placed in a position closer to a tab plate TB side among the plurality of copper foils stacked in the Z-axis direction are further joined to the tab plate TB in positions other than the joint portions BD21A, BD21B.

As described above, the blue laser welding system 100 according to Embodiment 2 can gradually melt the stacked metal foils AF and the tab plate TB by radiating the blue laser beam LB2 on the welding line WL2 set along the one end portion of the stacked metal foils AF such that the blue laser beam LB2 reciprocates a plurality of times while drawing a freely set shape. Accordingly, the blue laser welding system 100 can further join the stacked metal foils AF and the tab plate TB, and thus can further stabilize manufacturing of a product (workpiece) obtained by joining the stacked metal foils AF and the tab plate TB.

### Modifications of Embodiment 2

The above described an example of a laser welding method by the blue laser welding system 100 according to Embodiment 2, which is a welding method for performing welding by reciprocating the blue laser beam LB2 a plurality of times on the welding line WL2, for performing welding by adjusting a radiation width (amplitude) of the blue laser beam LB2 in a direction substantially orthogonal to the welding line WL2 to a prescribed size (constant). The following will describe an example of a laser welding method by the blue laser welding system 100 according to a modification of Embodiment 2, which is a welding method for performing welding by reciprocating the blue laser beam LB2 a plurality of times on the welding line WL2, in which the radiation width (amplitude) of the blue laser beam LB2 expands for each reciprocation.

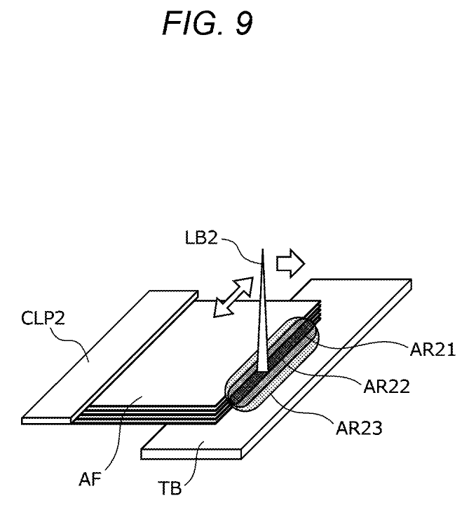

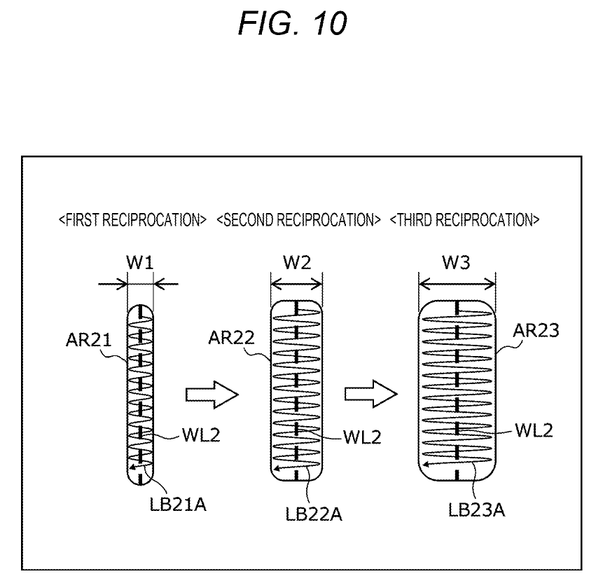

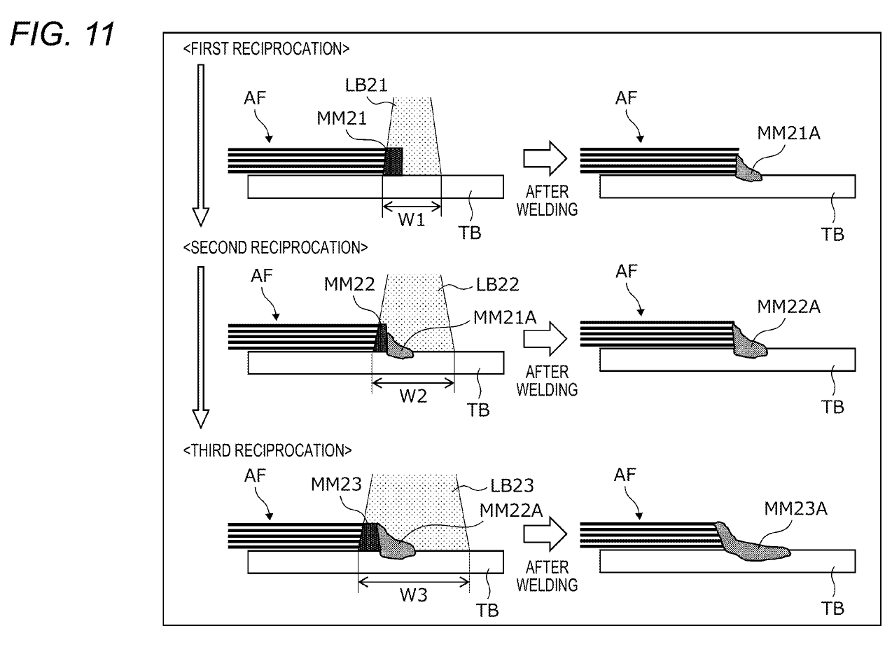

The laser welding method according to the modification of Embodiment 2 will be described with reference to FIGS. 9 to 11. FIG. 9 shows an example of a laser welding method for the stacked metal foils AF and the tab plate TB according to the modification of Embodiment 2. FIG. 10 shows an example of a change in amplitude of laser welding. In FIG. 9, no welding line is shown for sake of clarity. FIG. 10 shows an example in which the blue laser beam LB2 is radiated while weaving to draw a prescribed sine wave. FIG. 11 is a process view schematically showing time-series operation procedures of laser welding for the stacked metal foils AF and the tab plate TB.

The blue laser welding system 100 according to the modification of Embodiment 2 welds the stacked metal foils AF and the tab plate TB by a laser welding method in which the radiation width (amplitude) of the blue laser beam LB2 increases as the blue laser beam LB2 reciprocates on the welding line WL2.

As shown in FIG. 10, the blue laser welding system 100 executes radiation control of the blue laser beam LB2 such that the amplitude of the radiation trajectory of the blue laser beam LB2 increases as the number of reciprocations on the welding line WL2 increases. A radiation range AR21 is a radiation range of the blue laser beam LB2 of a first reciprocation. A radiation range AR22 indicates a radiation range of the blue laser beam LB2 of a second reciprocation. A radiation range AR23 indicates a radiation range of the blue laser beam LB2 of a third reciprocation.

A radiation trajectory LB21A indicates a radiation trajectory of the blue laser beam LB2 in a forward path or a backward path of a radiation trajectory of the blue laser beam LB2 radiated in the first reciprocation. A radiation trajectory LB22A indicates a radiation trajectory of the blue laser beam LB2 in a forward path or a backward path of a radiation trajectory of the blue laser beam LB2 radiated in the second reciprocation. A radiation trajectory LB23A indicates a radiation trajectory of the blue laser beam LB2 in a forward path or a backward path of a radiation trajectory of the blue laser beam LB2 radiated in the third reciprocation.

The blue laser welding system 100 performs welding on the welding line WL2 with an amplitude W1 in the first reciprocation, performs welding on the welding line WL2 with an amplitude W2 in the second reciprocation, and performs welding on the welding line WL2 with an amplitude W3 in the third reciprocation. Here, a magnitude relationship between the amplitudes W1 to W3 is W1 < W2 < W3. For example, the blue laser welding system 100 changes a radiation pattern of the blue laser beam LB2 such that the amplitude W1 is 300 μm, the amplitude W2 is 600 μm, and the amplitude W3 is 900 μm.

Centers of the amplitudes W1 to W3, that is, centers of the radiation ranges AR21 to AR23 of the blue laser beam LB2 may not coincide with the welding line WL2. For example, the blue laser beam LB2 may be radiated such that a position shifted from the welding line WL2 toward the tab plate TB or the stacked metal foils AF only in the third reciprocation is the center of the amplitudes W1 to W3, or be radiated such that the centers of the amplitudes W1 to W3 are shifted from the welding line WL2 toward the tab plate TB or the stacked metal foils AF each time the number of reciprocations is increased.

Further, the blue laser welding system 100 increases a moving speed of a radiation position of the blue laser beam LB2 such that radiation time of the blue laser beam LB2 radiated in each of the first reciprocation, the second reciprocation, and the third reciprocation remains the same, that is, as the number of reciprocations increases.

When the above-described laser welding method is performed, the stacked metal foils AF and the tab plate TB are welded and joined through a process shown in FIG. 11.

During radiation of the blue laser beam LB21 in the first reciprocation, copper foils of stacked metal foils MM21 irradiated with the blue laser beam LB21 which are located in a vicinity of the tab plate TB are broken and melted by the blue laser beam LB21 having a high power density. The tab plate TBis melted by heat received from radiation of the blue laser beam LB2, and is mixed with the broken and melted copper foils and solidified, so that a joint portion MM21A is formed between the tab plate TB and the stacked metal foils AF.

During radiation of the blue laser beam LB22 in the second reciprocation, the joint portion MM21A between the stacked metal foils AF and the tab plate TB is melted by heat received from radiation of the blue laser beam LB22. Further, in the stacked metal foils AF and the tab plate TB, stacked metal foils MM22 and a surface of the tab plate TB are further melted by the heat received from the blue laser beam LB22 and heat transferred from the melted joint portion MM21A and solidified, so that a joint portion MM22A is formed. In the joint portion MM22A, a melted amount of the stacked metal foils AF and the tab plate TB is larger than that in the joint portion MM21A, and more stable joining between the stacked metal foils AF and the tab plate TB is implemented.

During radiation of the blue laser beam LB23 in the third reciprocation, the joint portion MM22A between the stacked metal foils AF and the tab plate TB is melted by heat received from radiation of the blue laser beam LB23. Further, in the stacked metal foils AF and the tab plate TB, stacked metal foils MM23 and a surface of the tab plate TB are melted again by the heat received from the blue laser beam LB23 and heat transferred from the melted joint portion MM22A and solidified, so that a joint portion MM23A is formed. The joint portion MM23A implements more stable joining between the stacked metal foils AF and the tab plate TB by the joint portion MM22A being melted and solidified again. Further, the joint portion MM23A more uniformly joins the stacked metal foils AF and the tab plate TB with an expanded radiation range of the blue laser beam LB23 in the third reciprocation.

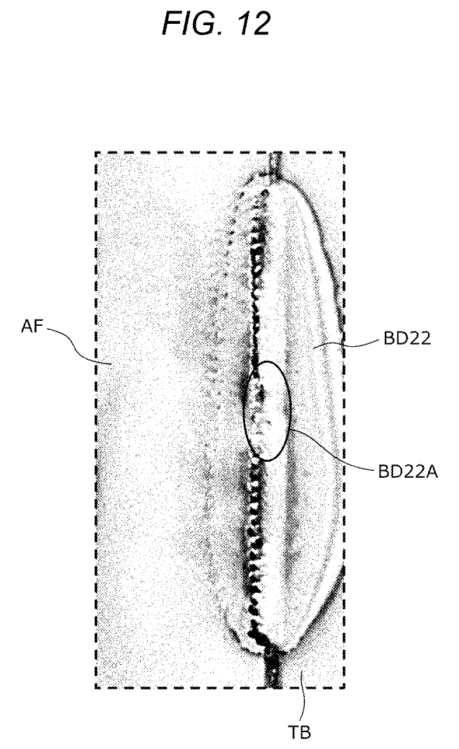

Next, a result of laser welding performed by the laser welding method shown in FIG. 9 will be described with reference to FIG. 12. FIG. 12 shows an example of a laser welding result of the stacked metal foils AF and the tab plate TB shown in FIG. 9.

In a weld bead BD22 formed by the laser welding method shown in FIG. 9, a joint portion BD22A where the stacked metal foils AF and the tab plate TB are joined is formed. The weld bead BD22 is formed in a state in which copper foils stacked in the Z-axis direction are further joined at a portion other than the joint portion BD22A.

As described above, the blue laser welding system 100 according to the modification of Embodiment 2 expands the amplitude of the blue laser beam LB2 each time the number of reciprocations on the welding line WL2 is increased, so that the radiation range of the blue laser beam LB2 can be expanded and the power density can be reduced, and accordingly the melted amount of the stacked metal foils AF and the tab plate TB can be gradually increased and a more stable joint portion can be formed. Further, the blue laser welding system 100 can more effectively restrict heat localization during welding and restrict damage to the stacked metal foils AF and the tab plate TB by expanding the radiation range of the blue laser beam LB2 and reducing the power density. Accordingly, the blue laser welding system 100 can further stabilize the joining between the stacked metal foils AF and the tab plate TB, and thus can further stabilize manufacturing of a product (workpiece) obtained by joining the stacked metal foils AF and the tab plate TB.

In Embodiment 2 and the modification of Embodiment 2, an example of reciprocating the blue laser beam LB2 three times on the welding line WL2 was described as an example, and the number of reciprocations is not limited to three. For example, the number of reciprocations may be freely set according to the number of copper foils, a thickness of the copper foil, and a material of the copper foils or the tab plate TB.

### Background of Embodiment 3

In the modification of Embodiment 2, when the laser welding method is performed, in which the blue laser beam LB2 that draws a freely set shape is reciprocated a plurality of times on the welding line WL2 and the radiation width of the blue laser beam LB2 is increased each time the number of reciprocations is increased, a welding result that the stacked metal foils AF and the tab plate TB can be more stably joined is obtained. However, in the laser welding method according to the modification of Embodiment 2, one end portion of the stacked metal foils AF may be lifted from the tab plate TB due to heat during radiation of the blue laser beam LB2 in the first reciprocation that has the highest power density.

Therefore, in Embodiment 3 described below, a method of radiating the blue laser beam LB2 for further reducing the lifting of the stacked metal foils AF in the welding for the stacked metal foils AF and the tab plate TB will be described. In the following description, the same components as those in Embodiment 1, Embodiment 2, and the modification of Embodiment 2 are denoted by the same reference numerals, and thus the description thereof will be omitted.

### Embodiment 3

The following will describe an example of a laser welding method in which the blue laser welding system 100 according to Embodiment 3 performs a step of joining a plurality of copper foils constituting the stacked metal foils AF before a welding step of performing welding on the welding line WL2.

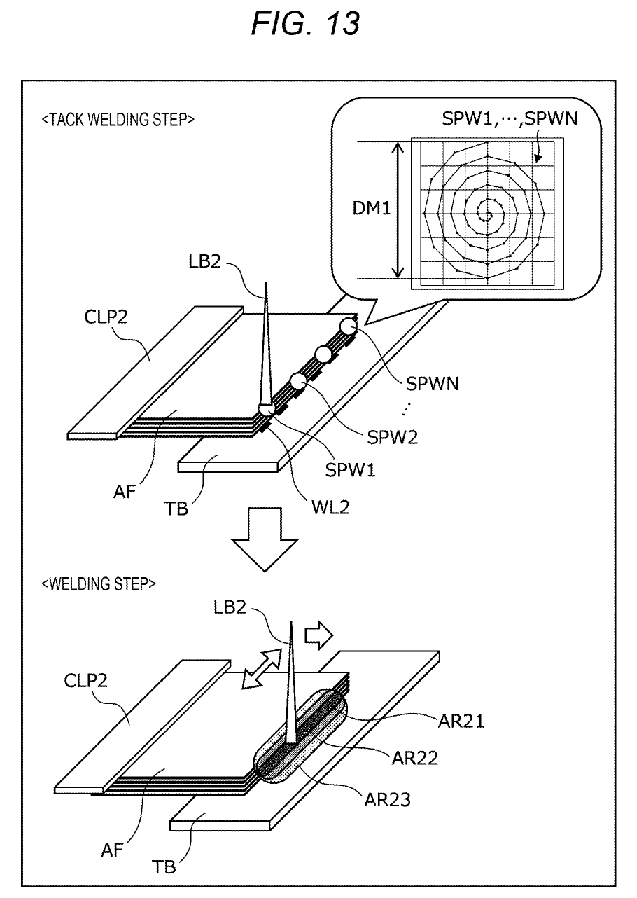

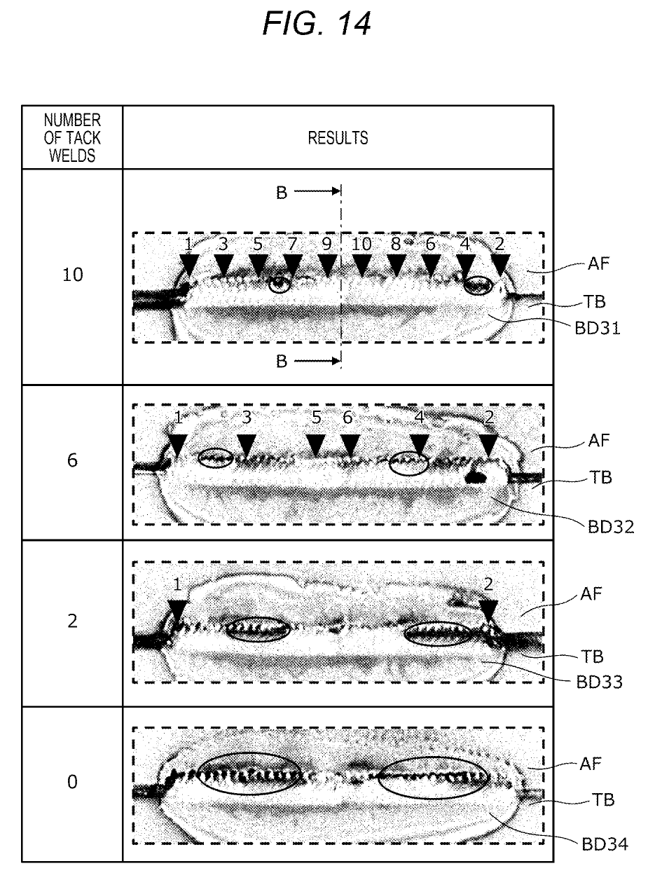

A laser welding method according to Embodiment 3 will be described with reference to FIGS. 13 and 14. FIG. 13 shows an example of a laser welding method for the stacked metal foils AF and the tab plate TB according to Embodiment 3. FIG. 14 shows an example of a laser welding result of the stacked metal foils AF and the tab plate TB shown in FIG. 13.

In FIG. 14, in each of weld beads BD31 to BD34, a defective portion of laser welding is indicated by ○, and a tack welding portion is indicated by ∇, and reference numerals are omitted. Further, at each tack welding portion (∇), a number indicating an order in which the tack weld is formed is indicated.

The blue laser welding system 100 according to Embodiment 3 performs the step of joining the plurality of copper foils constituting the stacked metal foils AF (hereinafter, referred to as "tack welding step") before performing the laser welding method (welding step) shown in Embodiment 2 or the modification of Embodiment 2. Similar to the laser welding method described in Embodiment 2 or the modification of Embodiment 2, the blue laser welding system 100 according to Embodiment 3 adjusts the focal position of the blue laser beam LB2 to −2.5 mm, and performs the tack welding step and the welding step.

As shown in FIG. 13, the blue laser welding system 100 performs tack welding for joining the plurality of copper foils constituting the stacked metal foils AF to each other at each of a plurality of tack welding portions along the welding line WL2. In the example shown in FIG. 13, the blue laser welding system 100 performs tack welding by radiating the blue laser beam LB2 in a spiral shape having a diameter DM1 from each of the plurality of tack welding portions as a start point, and forms a respective one of a plurality of tack welds SPW1, ..., SPWN in which a plurality of copper foils are joined to each other at one end portion of the stacked metal foils AF to be joined to the tab plate TB. The plurality of tack welds SPW1, ..., SPWN may not be arranged at equal intervals.

The diameter DM1 of the tack welds SPW1, ..., SPWN is, for example, 300 μm, and is equal to or smaller than the amplitude W1 of the blue laser beam LB2 radiated in the first reciprocation. The tack welds may be formed at least at two ends (start point and end point) of the welding line WL2.

To disperse heat generated by the radiation of the blue laser beam LB2, the blue laser welding system 100 performs tack welding in an order in which a tack welding order of the plurality of tack welding portions does not completely coincide with a welding direction on the welding line WL2. In the blue laser welding system 100, a part of the plurality of tack welding portions, such as two tack welding portions indicated by numbers "5" and "6" of the weld bead BD32 in FIG. 14, and the tack welding order may partially coincide with the welding direction on the welding line WL2.

First, the blue laser welding system 100 performs tack welding on each of two ends (start point and end point) of the welding line WL2 to form two tack welds SPW1, SPWN. Specifically, the blue laser welding system 100 performs tack welding on the tack welding portions corresponding to numbers "1" and "2" shown in FIG. 14 at two ends of the welding line WL2.

The blue laser welding system 100 tack-welds two ends of the welding line WL2, and then alternately tack-welds a tack welding portion located on one end side of the welding line WL2 and a tack welding portion located on another end side of the welding line WL2 among tack welding portions for which the tack welding is not completed. For example, as in a case of the weld bead BD32 (see FIG. 14), after the tack welding on the tack welding portions (two ends of the welding line WL2) corresponding to the numbers "1" and "2", the blue laser welding system 100 performs tack welding in an order of a tack welding portion indicated by a number "3" located on the one end side of the welding line WL2, a tack welding portion indicated by a number "4" located on the other end side of the welding line WL2, a tack welding portion indicated by a number "5" located on the one end side of the welding line WL2, and a tack welding portion indicated by a number "6" located on the other end side of the welding line WL2. Accordingly, the blue laser welding system 100 can more effectively restrict heat localization due to the radiation of the blue laser beam LB2 during the tack welding.

The blue laser welding system 100 performs the welding step by the laser welding method shown in Embodiment 2 or the modification of Embodiment 2 after performing the tack welding step, and joins the stacked metal foils AF and the tab plate TB.

Each of the weld beads BD31, BD32, and BD33 shown in FIG. 14 is a weld bead formed by performing the same welding step after performing the tack welding step of forming tack welds in different numbers. The weld bead BD34 is a weld bead in a case where the tack welding step is omitted, that is, the number of tack welds is 0 (zero). FIGS. 13 and 14 show an example in which a length of the welding line WL2 is 30 mm, and it is needless to say that the length of the welding line WL2 is not limited thereto.

The weld bead BD31 in which ten tack welds are formed and the weld bead BD32 in which six tack welds are formed have fewer defective portions than the weld bead BD33 in which two tack welds are formed and the weld bead BD34 in which the formation of tack welds is omitted.

As described above, in the example shown in FIG. 14, the blue laser welding system 100 can restrict variation among the plurality of copper foils constituting the stacked metal foils AF and the lifting of the stacked metal foils AF from the tab plate TB by forming six or more tack welds on the welding line WL2 having a length of 30 mm in the number of tack welding when welding the stacked metal foils AF and the tab plate TB, and can implement laser welding more suitable for joining the stacked metal foils AF and the tab plate TB. The number of tack welding may be freely changed according to the length of the welding line WL2. For example, when the length of the welding line WL2 is 30 mm or more, an interval between tack welds is large, and thus the interval between the tack welds may be adjusted by setting the number of tack welds to six or more. On the other hand, when the length of the welding line WL2 is less than 30 mm, the number of tack welds may be set to less than six since the interval between the tack welds is small. The number of tack welds may be freely changed depending on the number of copper foils, the thickness of the copper foil, the material of the copper foil or the tab plate TB, and the like.

In addition, the blue laser welding system 100 can more effectively restrict lifting of two ends of the stacked metal foils AF at which the lifting is likely to occur due to heat of the blue laser beam LB2 by performing tack welding from two portions of two ends (start point and end point) of the welding line WL2, and can implement laser welding more suitable for joining the stacked metal foils AF and the tab plate TB.

In addition, the blue laser welding system 100 can disperse the heat due to the radiation of the blue laser beam LB2 by alternately performing tack welding on a tack welding portion located on the one end side of the welding line WL2 and a tack welding portion located on the other end side of the welding line WL2 regarding tack welding portions for which the tack welding is not completed after the tack welding is performed on two portions of two ends (start point and end point) of the welding line WL2. Therefore, the blue laser welding system 100 can implement laser welding more suitable for joining the stacked metal foils AF and the tab plate TB by restricting variation between the plurality of copper foils constituting the stacked metal foils AF or lifting of the stacked metal foils AF from the tab plate TB during tack welding.

Embodiment 3 described an example in which a tack weld having a spiral shape is formed, and the shape or a forming method of the tack weld is not limited thereto. For example, the tack weld may be formed by a method of performing fixed point radiation of the blue laser beam LB2 for prescribed time, or be formed by a method of performing pulse control on an output of the blue laser beam LB2 and performing radiation a prescribed number of times. Further, the shape of the tack weld may be circular. The shape or the forming method may be freely combined depending on the number of copper foils, the thickness of the copper foil, the material of the copper foil or the tab plate TB, and the like.

A beam shape of the blue laser beam LB2 radiated in Embodiment 3 may be, for example, a ring shape, a ring shape, or a shape obtained by combining peak shapes, and may be freely set depending on the number of copper foils, the thickness of the copper foil, the material of the copper foil or the tab plate TB, and the like.

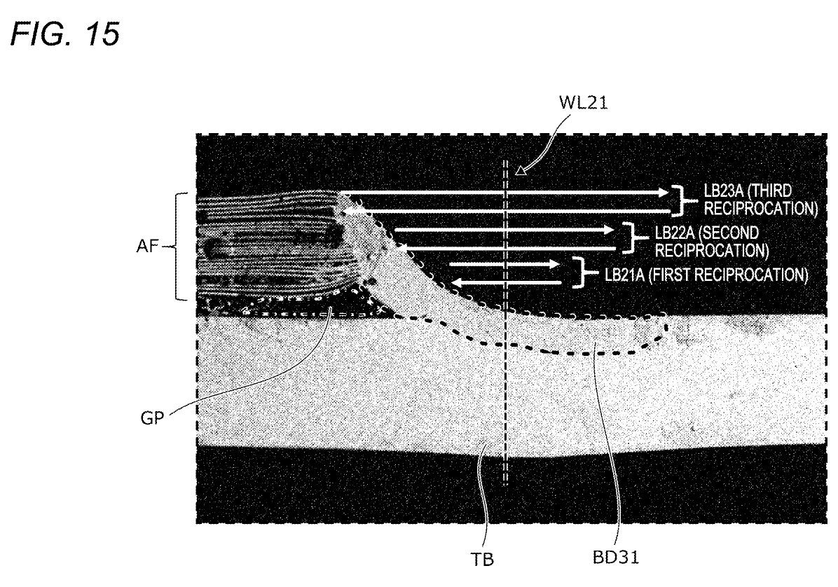

Next, a result of laser welding performed using the tack welding step and the welding step shown in Embodiment 1, the modification of Embodiment 2, and Embodiment 3 will be described with reference to FIG. 15. FIG. 15 is a cross-sectional view of the weld bead BD31 taken along a line B-B shown in FIG. 14.

The weld bead BD31 formed by the tack welding step and the welding step shown in Embodiment 1, the modification of Embodiment 2, and Embodiment 3 is generated by melting, by the blue laser beam LB2 radiated and reciprocated three times along the welding line WL2, and solidifying the stacked metal foils AF and the tab plate TB. A welding position WL21 indicates a position of the welding line WL2.

The blue laser welding system 100 performs irradiation while expanding the radiation range of the blue laser beam LB2, thereby obliquely joining the stacked metal foils AF in which the weld bead BD31 is not melted and the tab plate TB that is not melted with a substantially uniform thickness. Accordingly, the blue laser welding system 100 can expand an area (that is, joining area) of the weld bead BD31, which is a joint portion between the stacked metal foils AF and the tab plate TB, and thus can implement more stable joining between the stacked metal foils AF and the tab plate TB. Therefore, the blue laser welding system 100 can reduce a risk of breakage of the metal foils by making tension applied to the weld bead BD31, which is the joint portion between the stacked metal foils AF and the tab plate TB, more uniform. In addition, the blue laser welding system 100 can reduce a resistance value in electrical connection by expanding a joining area between the stacked metal foils AF and the tab plate TB, and thus it is possible to improve a performance of a battery using the stacked metal foils AF and the tab plate TB after joining and extend life of the battery.

The stacked metal foils AF and the tab plate TB after laser welding maintain a prescribed gap between the copper foils, and the stacked metal foils AF and the tab plate TB are joined in a state of being substantially parallel to each other. Accordingly, the blue laser welding system 100 can make the tension applied to the weld bead BD31, which is the joint portion between the stacked metal foils AF and the tab plate TB, more uniform, and thus can more effectively restrict breakage of the joint portion between the stacked metal foils AF and the tab plate TB and implement more stable joining.

Further, a gap GP is defined between the stacked metal foils AF and the tab plate TB after laser welding.

As described above, the blue laser welding system 100 according to Embodiment 3 can further stabilize manufacturing of a product (workpiece) in which the stacked metal foils AF and the tab plate TB are joined by performing the welding step of welding the stacked metal foils AF and the tab plate TB after performing the tack welding step of joining the plurality of copper foils constituting the stacked metal foils AF by tack-welding the plurality of tack welding portions along the welding line WL2.

The tack welding step and the welding step can be implemented by the same equipment. Therefore, the blue laser welding system 100 can further stabilize the manufacturing of a workpiece while minimizing a process equipment and restricting a decrease in productivity, and thus can improve productivity of a workpiece that is a non-defective product.

Although Embodiments 1 to 3 respectively described different laser welding methods, the laser welding methods described in Embodiments 1 to 3 may be freely combined.

### Appendixes

Following techniques are disclosed based on description of the embodiments.

### Technique 1-1

A laser welding method for joining stacked metal foils AF in which a plurality of copper-based foils are stacked and a tab plate TB formed of a copper-based material, the laser welding method including:

a step of placing one end of the stacked metal foils AF on the tab plate TB; and

a step of irradiating the one end of the stacked metal foils AF and the tab plate TB with a blue laser beam 70, LB2 by reciprocating the blue laser beam 70, LB2 a plurality of times on a welding line WL2 on the tab plate TB along the one end of the stacked metal foils AF.

With this configuration, since the blue laser beam is reciprocated on the welding line WL2 a plurality of times, the blue laser welding system 100 can gradually increase the melting amount of the stacked metal foils AF and the tab plate TB and form a more stable joint portion. Therefore, the blue laser welding system 100 can further stabilize manufacturing of a product (workpiece) obtained by joining the stacked metal foils AF and the tab plate TB.

### Technique 1-2

The laser welding method according to (technique 1-1), wherein

the blue laser beam 70, LB2 is radiated in a different radiation range for each reciprocation on the welding line WL2.

With this configuration, the blue laser welding system 100 can more effectively restrict heat localization in the radiation range of the blue laser beam LB2, gradually increase the melting amount of the stacked metal foils AF and the tab plate TB, and form a more stable joint portion. Accordingly, the blue laser welding system 100 can further stabilize the manufacturing of a product (workpiece) obtained by joining the stacked metal foils AF and the tab plate TB.

### Technique 1-3

The laser welding method according to (technique 1-1) or (technique 1-2), wherein

a radiation range of the blue laser beam 70, LB2 increases for each reciprocation on the welding line WL2.

With this configuration, the blue laser welding system 100 can gradually increase the melting amount of the stacked metal foils AF and the tab plate TB while expanding the radiation range of the blue laser beam LB2 by expanding the amplitude of the blue laser beam LB2 each time the number of reciprocations on the welding line WL2 is increased, and can form a more stable joint portion. Further, the blue laser welding system 100 can more effectively restrict heat localization and restrict damage to the stacked metal foils AF and the tab plate TB by expanding the radiation range of the blue laser beam LB2 and reducing the power density. Accordingly, the blue laser welding system 100 can further stabilize the joining between the stacked metal foils AF and the tab plate TB, and thus can further stabilize the manufacturing of a product (workpiece) obtained by joining the stacked metal foils AF and the tab plate TB.

### Technique 1-4

The laser welding method according to any one of (technique 1-1) to (technique 1-3), wherein

time in which the blue laser beam reciprocates on the welding line is constant.

With this configuration, in the blue laser welding system 100, by making the reciprocating time of the blue laser beam LB2 constant and expanding the radiation range, a scanning speed of the blue laser beam LB2 increases, and a power density per unit time during welding decreases, and thus heat localization can be more effectively restricted, and damage to the stacked metal foils AF and the tab plate TB can be restricted. Accordingly, the blue laser welding system 100 can further stabilize the joining between the stacked metal foils AF and the tab plate TB, and thus can further stabilize the manufacturing of a product (workpiece) obtained by joining the stacked metal foils AF and the tab plate TB.

### Technique 1-5

The laser welding method according to any one of (technique 1-1) to (technique 1-4), wherein

the blue laser beam 70, LB2 is wobbled or weaved.

With this configuration, the blue laser welding system 100 can more effectively restrict heat localization in the radiation range of the blue laser beam LB2, restrict damage to the stacked metal foils AF and the tab plate TB, and form a more stable joint portion by increasing the melted amount of the stacked metal foils AF and the tab plate TB. Accordingly, the blue laser welding system 100 can further stabilize the joining between the stacked metal foils AF and the tab plate TB, and thus can further stabilize the manufacturing of a product (workpiece) obtained by joining the stacked metal foils AF and the tab plate TB.

### Technique 1-6

The laser welding method according to any one of (technique 1-1) to (technique 1-5), wherein

a focal position of the blue laser beam 70, LB2 is set to a prescribed height from a surface of the tab plate TB.

With this configuration, the blue laser welding system 100 can reduce the power density of the blue laser beam LB1 and restrict the spatters. Accordingly, a welding failure due to spatters in the welding of the stacked metal foils AF and the tab plate TB is more effectively restricted, so that the blue laser welding system 100 can further stabilize the manufacturing of a product (workpiece) obtained by joining the stacked metal foils AF and the tab plate TB.

### Technique 2-1

A laser welding method for joining stacked metal foils AF in which a plurality of copper-based foils are stacked and a tab plate TB formed of a copper-based material, the laser welding method including:

a step of placing one end of the stacked metal foils AF on the tab plate TB;

a step of irradiating a plurality of tack welding positions on the one end of the stacked metal foils AF with a blue laser beam 70, LB2; and

a step of irradiating a welding line WL2 on the tab plate TB along the one end of the stacked metal foils AF with the blue laser beam 70, LB2.

With this configuration, a plurality of tack welds are formed, so that the blue laser welding system 100 can restrict variation between the plurality of copper foils constituting the stacked metal foils AF and lifting of the stacked metal foils AF from the tab plate TB, and can implement laser welding more suitable for joining the stacked metal foils AF and the tab plate TB.

### Technique 2-2

The laser welding method according to (technique 2-1), wherein

the plurality of tack welding positions include at least one end and another end of the welding line WL2.

With this configuration, the blue laser welding system 100 can more effectively restrict lifting of two ends of the stacked metal foils AF at which the lifting is likely to occur due to heat of the blue laser beam LB2 by performing tack welding in the plurality of tack welding positions including two portions of two ends (start point and end point) of the welding line WL.

### Technique 2-3

The laser welding method according to (technique 2-2), wherein

in the step of irradiating the plurality of tack welding positions with the blue laser beam 70, LB2,

when there are three or more tack welding positions, the one end and the other end of the welding line WL2 among the plurality of tack welding positions are irradiated with the blue laser beam 70, LB2, and then the tack welding position other than the one end and the other end of the welding line WL2 is irradiated with the blue laser beam 70, LB2.

With this configuration, the blue laser welding system 100 can more effectively restrict lifting of two ends of the stacked metal foils AF at which the lifting is likely to occur due to heat of the blue laser beam LB2 by performing tack welding from two portions of two ends (start point and end point) of the welding line WL2, and can implement laser welding more suitable for joining the stacked metal foils AF and the tab plate TB.

### Technique 2-4

The laser welding method according to (technique 2-2), wherein

in the step of irradiating the plurality of tack welding positions with the blue laser beam 70, LB2,

when there are a plurality of tack welding positions other than the one end and the other end of the welding line WL2, a first tack welding position located on one end side of the welding line WL2 and a second tack welding position located on another end side of the welding line WL2 of the plurality of tack welding positions are alternately irradiated with the blue laser beam 70, LB2.

With this configuration, the blue laser welding system 100 can more effectively restrict heat localization due to the radiation of the blue laser beam LB2 during the tack welding.

### Technique 2-5

The laser welding method according to any one of (technique 2-1) to (technique 2-4), wherein

in the step of irradiating the plurality of tack welding positions with the blue laser beam 70, LB2,

the blue laser beam 70, LB2 is spirally radiated in each of the plurality of tack welding positions.

With this configuration, the blue laser welding system 100 can more effectively restrict heat localization due to the radiation of the blue laser beam LB2 during the tack welding.

### Technique 2-6

The laser welding method according to any one of (technique 2-1) to (technique 2-5), wherein

a focal position of the blue laser beam 70, LB2 is set to a prescribed height from a surface of the tab plate TB.

With this configuration, the blue laser welding system 100 can reduce a power density of the blue laser beam LB1 and restrict spatters. Accordingly, a welding failure due to spatters in the welding of the stacked metal foils AF and the tab plate TB is more effectively restricted, so that the blue laser welding system 100 can further stabilize manufacturing of a product (workpiece) obtained by joining the stacked metal foils AF and the tab plate TB.

### Technique 3-1

A laser welding method for joining stacked metal foils AF in which a plurality of copper-based foils are stacked and a tab plate TB formed of a copper-based material, the laser welding method including:

a step of placing one end of the stacked metal foils AF on the tab plate TB; and

a step of irradiating the one end of the stacked metal foils AF and the tab plate TB with a blue laser beam 70, LB2 by reciprocating the blue laser beam 70, LB2 a plurality of times along a welding line WL2 on the tab plate TB along the one end of the stacked metal foils AF, wherein

the stacked metal foils AF and the tab plate TB irradiated with the blue laser beam 70, LB2 have a joint portion in which a portion between a surface of the tab plate TB irradiated with the blue laser beam 70, LB2 and the one end of the stacked metal foils AF is obliquely joined to the surface of the tab plate TB.

With this configuration, the blue laser welding system 100 can make tension applied to a weld bead BD31, which is the joint portion between the stacked metal foils AF and the tab plate TB, more uniform, and thus can more effectively restrict breakage of the joint portion between the stacked metal foils AF and the tab plate TB and implement more stable joining. Therefore, the blue laser welding system 100 can further stabilize manufacturing of a product (workpiece) obtained by joining the stacked metal foils AF and the tab plate TB.

(Technique 3-2)

The laser welding method according to (technique 3-1), wherein

the joint portion connects the plurality of copper-based foils and the surface of the tab plate TB substantially in parallel.

With this configuration, the blue laser welding system 100 can make the tension applied to the weld bead BD31, which is the joint portion between the stacked metal foils AF and the tab plate TB, more uniform. In addition, the blue laser welding system 100 can reduce a resistance value in electrical connection by expanding a joining area between the stacked metal foils AF and the tab plate TB, and thus it is possible to improve a performance of a battery using the stacked metal foils AF and the tab plate TB after joining and extend life of the battery.

### Technique 3-3

The laser welding method according to (technique 3-1) or (technique 3-2), wherein

a radiation range of the blue laser beam 70, LB2 increases for each reciprocation on the welding line WL2.

With this configuration, the blue laser welding system 100 can expand an area (that is, joining area) of the weld bead BD31, which is the joint portion between the stacked metal foils AF and the tab plate TB, and thus can implement more stable joining between the stacked metal foils AF and the tab plate TB.

### Technique 3-4

The laser welding method according to any one of (technique 3-1) to (technique 3-3), wherein

the blue laser beam 70, LB2 is wobbled or weaved.

With this configuration, the blue laser welding system 100 can expand an area (that is, joining area) of the weld bead BD31, which is the joint portion between the stacked metal foils AF and the tab plate TB, and thus can implement more stable joining between the stacked metal foils AF and the tab plate TB.

### Technique 3-5

The laser welding method according to any one of (technique 3-1) to (technique 3-4), wherein

a focal position of the blue laser beam 70, LB2 is set to a prescribed height from a surface of the tab plate TB.

With this configuration, the blue laser welding system 100 can reduce a power density of the blue laser beam LB1 and restrict spatters. Accordingly, a welding failure due to spatters in the welding of the stacked metal foils AF and the tab plate TB is more effectively restricted, so that the blue laser welding system 100 can further stabilize manufacturing of a product (workpiece) obtained by joining the stacked metal foils AF and the tab plate TB.

With this configuration, a welding failure due to spatters in the welding of the stacked metal foils AF and the tab plate TB is more effectively restricted, so that the blue laser welding system 100 can further stabilize manufacturing of a product (workpiece) obtained by joining the stacked metal foils AF and the tab plate TB.

Although embodiments are described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the various embodiments described above may be combined freely in a range without departing from the spirit of the invention.

The present application is based on a Japanese patent application filed on September 22, 2023 (JP2023-159150A), and contents thereof are incorporated herein by reference.

### INDUSTRIAL APPLICABILITY

The present disclosure is useful as a laser welding method for joining a plurality of metal foils and a metal plate.

What is claimed is:

1. A laser welding method for joining stacked metal foils in which a plurality of copper-based foils are stacked and a tab plate formed of a copper-based material, the laser welding method comprising:
placing one end of the stacked metal foils on the tab plate;
irradiating a plurality of tack welding positions on the one end of the stacked metal foils with a blue laser beam; and
irradiating a welding line on the tab plate along the one end of the stacked metal foils with the blue laser beam.

2. The laser welding method according to claim 1, wherein
the plurality of tack welding positions include at least one end and another end of the welding line.

3. The laser welding method according to claim 2, wherein
in the irradiating the plurality of tack welding positions with the blue laser beam,
when there are three or more tack welding positions, the one end and the other end of the welding line among the plurality of tack welding positions are irradiated with the blue laser beam, and then the tack welding position other than the one end and the other end of the welding line is irradiated with the blue laser beam.

4. The laser welding method according to claim 2, wherein
in the irradiating the plurality of tack welding positions with the blue laser beam,
when there are a plurality of tack welding positions other than the one end and the other end of the welding line, a first tack welding position located on one end side of the welding line and a second tack welding position located on another end side of the welding line of the plurality of tack welding positions are alternately irradiated with the blue laser beam.

5. The laser welding method according to claim 1, wherein
in the irradiating the plurality of tack welding positions with the blue laser beam,
the blue laser beam is spirally radiated in each of the plurality of tack welding positions.

6. The laser welding method according to claim 1, wherein
a focal position of the blue laser beam is set to a prescribed height from a surface of the tab plate.
